(19) United States
(12) Patent Application Publication
(10) Pub. No.: US 2018/0201035 A1
(43) Pub. Date: Jul. 19, 2018

(54) PRINTERS AND METHODS FOR DETECTING PRINT MEDIA THICKNESS THEREIN

(71) Applicant: Datamax-O'Neil Corporation, Orlando, FL (US)

(72) Inventors: Boon Kheng Lim, Singapore (SG); Aravindkumar Harinarayanan, Singapore (SG); Danny Lim, Singapore (SG)

(21) Appl. No.: 15/795,353

(22) Filed: Oct. 27, 2017

Related U.S. Application Data
(63) Continuation of application No. 15/408,572, filed on Jan. 18, 2017, now Pat. No. 9,802,427.

(51) Int. Cl. B41J 13/00; B41J 11/00

(52) U.S. Cl. CPC B41J 13/0009; B41J 11/0035; B41J 11/0095

(57) ABSTRACT

Printer is provided having support base on which print media travels. Printer includes thickness detection module and processor. Thickness detection module includes pinch arm assembly with pinch arm having first and second ends, encoder, and proximate dual channel encoder sensor. First end is biased toward support base. Encoder with number of circumferentially spaced line pairs is disposed at second end. Pinch arm and encoder configured to rotate in response to engagement of pinch arm with at least print media portion. Dual channel encoder sensor configured to detect rotation direction and encoder count and output signal representing encoder count. Encoder count is number of circumferentially spaced line pairs that pass by dual channel encoder sensor as pinch arm and encoder rotate. Processor is communicatively coupled to dual channel encoder sensor and configured to receive signal and calculate print media thickness of portion from encoder count using conversion factor.

### CROSS-REFERENCE TO RELATED APPLICATION

The present application claims the benefit of U.S. patent application Ser. No. 15/408,572 for Printers and Methods for Detecting Print Media Thickness Therein filed Jan. 18, 2017, now U.S. Pat. No. 9,802,427. Each of the foregoing patent application and patent is hereby incorporated by reference in its entirety.

### FIELD OF THE INVENTION

The present invention relates to printers and methods for detecting print media thickness therein.

### BACKGROUND

A thermal transfer printer conventionally includes a thermal print head utilized to thermally transfer a portion of ink from an ink ribbon to print media such as paper, labels, tickets, etc. as the ink ribbon is unwound. The thermal print head presses against the print media to thermally transfer the ink portion thereto.

The pressure of the thermal print head against the print media affects print registration and print quality. The correct pressure depends upon the thickness of the print media. Thermal print head pressure may be set by the user and the setting may not be optimum or correct for the thickness of the print media, resulting in unsatisfactory print registration and print quality.

Therefore, a need exists for systems and methods for detecting a print media thickness of print media in a printer, to provide for an optimal thermal pressure head (TPH) pressure on the print media having the detected print media thickness.

### SUMMARY

Printer is provided having support base on which print media travels, according to various embodiments. Printer includes thickness detection module and processor. Thickness detection module includes pinch arm assembly with pinch arm having first and second ends, encoder, and proximate dual channel encoder sensor. First end is biased toward support base. Encoder with number of circumferentially spaced line pairs is disposed at second end. Pinch arm and encoder configured to rotate in response to engagement of pinch arm with at least print media portion. Dual channel encoder sensor configured to detect rotation direction and encoder count and output signal representing encoder count. Encoder count is number of circumferentially spaced line pairs that pass by dual channel encoder sensor as pinch arm and encoder rotate. Processor is communicatively coupled to dual channel encoder sensor and configured to receive signal and calculate print media thickness of portion from encoder count using conversion factor.

A method for detecting the thickness of print media in a printer is provided, according to various embodiments. The method comprises setting an encoder count to zero in response to receiving a no print media sensor signal, receiving a signal from a dual channel encoder sensor proximate an encoder disposed at an end of a pinch arm, and in response to receiving the signal, calculating the print media thickness of the print media from the encoder count using a conversion factor. The encoder has a number of circumferentially spaced line pairs. The signal represents a rotation direction and the encoder count comprising the number of circumferentially spaced line pairs that, during a time interval, pass by the dual channel encoder sensor as the pinch arm and encoder rotate in the rotation direction.

An assembly configured to detect a print media thickness in a printer is provided, according to various embodiments. The assembly comprises a pinch arm having a first end and a second end, an encoder disposed at the second end of the pinch arm, a dual channel encoder sensor proximate the encoder; and a biasing element for urging the pinch arm into engagement with at least a portion of the print media. The encoder has a number of circumferentially spaced line pairs. The pinch arm and encoder are configured to rotate in response to engagement of the pinch arm with at least the portion of the print media.

The foregoing illustrative summary, as well as other exemplary objectives and/or advantages of the invention, and the manner in which the same are accomplished, are further explained within the following detailed description and its accompanying drawings.

### BRIEF DESCRIPTION OF THE DRAWINGS

FIG. 1 graphically illustrates a portion of an exemplary printer that may be used in a method for detecting a print media thickness according to various embodiments, a cover of the printer removed to illustrate a print control assembly and a thickness detection module (the encircled region) of the printer according to various embodiments;

FIG. 2 graphically illustrates an exemplary ribbon path B of an ink ribbon and a media path C of the print media used in the printer of FIG. 1, according to various embodiments;

FIG. 3 schematically depicts components of the thickness detection module of the exemplary printer of FIG. 1, illustrating a pinch arm assembly located above a support base in the thickness detection module, the pinch arm assembly comprising a pinch arm attached to an encoder proximate a dual channel encoder sensor and a biasing element mounted to a bracket above the support base for urging a print media engagement end of the pinch arm toward the support base, according to various embodiments;

FIG. 4 schematically depicts in isolation components of the pinch arm assembly of FIG. 3, illustrating the pinch arm assembly located above the support base, the pinch arm of the pinch arm assembly having a length r and the encoder having a sensing radius R and the bracket and support base defining a channel along the media path C for print media to be fed into and passed therethrough on its way to the thermal print head of the exemplary printer of FIGS. 1 and 2, according to various embodiments;

FIGS. 5A and 5B depict clockwise rotation of the pinch arm and encoder from a first position (FIG. 5A) in which the print media engagement end of the pinch arm is engaged with a liner only portion of the print media (i.e., “thin” print media) passing through the channel between the support base and the bracket of the thickness detection module (FIGS. 1 and 2) to a second position in which the print media engagement end of the pinch arm is engaged with “thick print media” comprising a print medium portion and an underlying liner portion) with a corresponding increase in encoder count (not shown in FIGS. 5A and 5B; see FIG. 7B), according to various embodiments (a so-called “thin to thick embodiment”);

FIGS. 6A and 6B graphically depicts counterclockwise movement of the pinch arm from a first position (FIG. 6A) in which the first end of the pinch arm is engaged with the thick print media (the print medium portion and an underlying liner portion) passing through the channel such as in FIG. 5B to a second position in which the first end of the print media is engaged with the liner only portion of the print media (i.e., the thin print media) (a so-called “thick to thin embodiment”) with a corresponding decrease in encoder count (not shown in FIGS. 6A and 6B; see FIG. 7B), the rotational direction of the pinch arm and encoder different depending upon whether the print media thickness increases (thin to thick) or decreases (thick to thin) according to various embodiments;

FIGS. 7A and 7B graphically depict the print media 22 of FIGS. 5A through 6B and conversion of an encoder count to print media thickness using an exemplary conversion factor comprising an encoder count of 5 equal to a print media thickness of 0.1 mm, with the encoder count being zero when there is no print media in the printer, the encoder count being 5 when the print media engagement end engages with the liner only portion of the print media (FIGS. 5A and 6B) making the liner 0.1 mm thick (liner_{Th}), the encoder count being 15 when the print media engagement end engages with the thick print media (the print medium portion and the underlying liner) (FIGS. 5B and 6A) making the thick print media 0.3 mm thick (Th) and the print medium portion 0.2 mm thick (0.3 mm minus 0.1 mm), according to various embodiments; and

FIG. 8 is a flow diagram of a method for detecting print media thickness of print media in a printer, according to various embodiments.

### DETAILED DESCRIPTION

Various embodiments are directed to printers and systems and methods for detecting a print media thickness of print media in a printer. Various embodiments permit an automatic thermal print head (TPH) pressure adjustment depending on the detected print media thickness, thereby improving print registration and print quality.

As used herein, the term “printer” refers to a device that prints text, barcodes and other information-bearing indicia, illustrations, etc. onto print media (e.g., labels, tickets, plain paper, receipt paper, plastic transparencies, and the like). Various embodiments of the present invention will be described in relation to a thermal transfer printer that uses an ink ribbon to supply media (e.g., ink) and a thermal print head that thermally transfers a portion of the ink from the ink ribbon onto the print media as the ink ribbon is unwound. However, the present invention may be equally applicable to other types and styles of printers that may benefit from detecting the print media thickness. As noted previously, the thermal print head (TPH) pressure as it thermally transfers the portion of the ink from the ink ribbon onto the print media affects print registration and print quality.

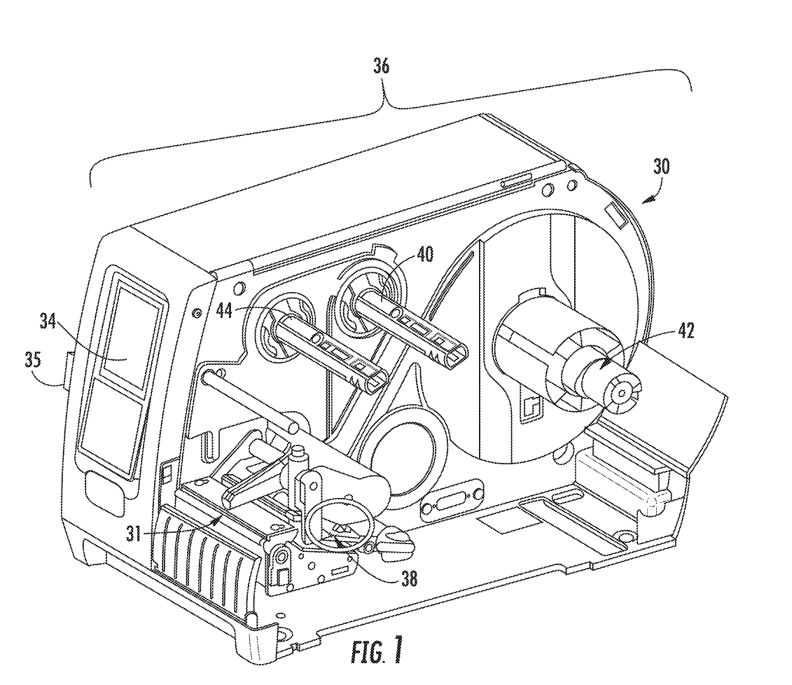

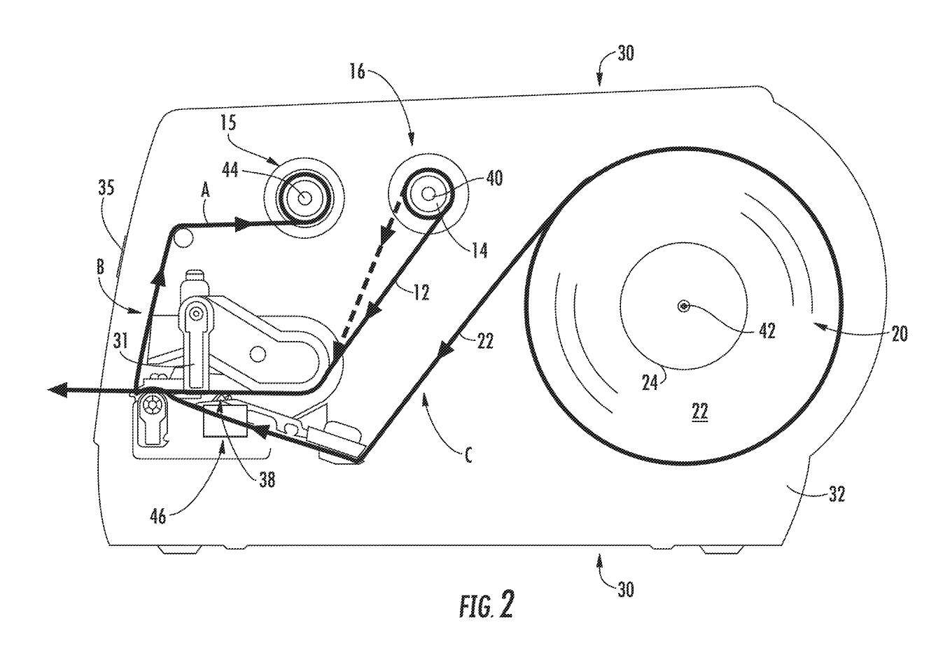

Now referring to FIG. 1, according to various embodiments, an exemplary printer 30 capable of printing on print media 22 is partially shown. The depicted printer 30 has a body 32 including a user interface 34 for communication between a user and the printer 30, a processor 35, a print control assembly 36, a power source, and a moveable cover (removed in FIG. 1 for purposes of illustration) for accessing, for example, the interior of the body 32 and the components contained therein. While the illustrated print control assembly 36 is contained within the body 32 of the printer 30, it is to be understood that the print control assembly 36 may be external of the printer. Still referring to FIG. 1, and now briefly to FIGS. 2 through 3, according to various embodiments, the printer 30 further comprises a thickness detection module 38 (encircled region in FIG. 1) contained within the body 32. The printer 30 may have other components as known in the art, such as a print slot from which the printed media exits from the printer 30, and a cutting assembly for assisting in the cutting or separation of the printed medium from non-continuous print media.

Still referring to FIG. 1, the user interface 34 may include, but is not limited to, a display for displaying information, a keypad for entering data, and function buttons that may be configured to perform various typical printing functions (e.g., cancel print job, advance print media, and the like) or be programmable for the execution of macros containing preset printing parameters for a particular type of print media. Additionally, the user interface 34 may be operationally/communicatively coupled to the processor (CPU) for controlling the operation of the printer 30, in addition to other functions discussed below in greater detail. The user interface 34 may be supplemented by or replaced by other forms of data entry or printer control such as a separate data entry and control module linked wirelessly or by a data cable operationally coupled to a computer, a router, or the like.

As known in the art, the central processing unit (CPU) (i.e., the processor 35) is the electronic circuitry within a computer that carries out the instructions of a computer program by performing the basic arithmetic, logical, control and input/output (I/O) operations specified by the instructions as hereinafter described. According to various embodiments, the processor 35 is configured by a software program to perform the steps as hereinafter described. In accordance with various embodiments as hereinafter described, the processor 35 is configured, by the software program, to prompt a user to remove the print media from the printer, set an encoder count to zero after the print media has been removed from the printer, receive a signal representing rotation direction and encoder count, and calculate a print media thickness from the encoder count.

Still referring to FIG. 1 and again to FIG. 2, according to various embodiments, the print control assembly 36 comprises a ribbon supply spindle 40 on which a ribbon roll 16 is configured to be disposed, a media supply spindle 42 on which a media roll 20 (FIG. 2) is configured to be disposed, and a ribbon rewind spindle 44 on which unwound ribbon is wound up. The ribbon roll 16 comprises ink ribbon 12 continuously wound up on a ribbon core 14 that may be, for example, a cardboard tube. As used herein, the ink ribbon 12 may be of various types, including different widths, lengths, thicknesses, ink colors, ribbon materials, and so forth. The ribbon roll 16 is configured to rotate in a forward or a backward rotational direction, depending on the winding type as depicted in FIG. 2. An empty ribbon take 15 may be disposed on the ribbon rewind spindle 44 although the empty ribbon take (e.g., empty ribbon take 15 on the left in FIG. 2) on the ribbon rewind spindle 44 may not be necessary.

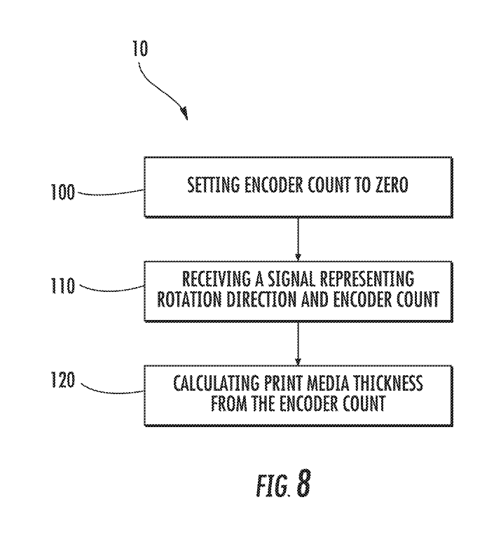

The media roll 20 comprises print media 22 wound on a media core 24. As noted previously, the print media 22 may comprise labels, tickets, plain paper, receipt paper, plastic transparencies, and the like. The print media may be continuous or non-continuous. Non-continuous print media 22 may comprise a liner portion 22a underlying a plurality of individual print medium 22b (a print medium portion) (e.g., a label) to define a liner only portion 22a-1 between each of the individual print medium 22b. As shown in FIG. 7A, the liner only portion 22a/22a-1 of the print media 22 and the print media each have a different print media thickness (Print media_{Th}). The print media thickness is detected by methods for detecting print media thickness accordance to various embodiments of the present invention as described herein, such that the thermal print head pressure on the print media is automatically adjusted to an optimal TPH pressure for the detected print media thickness, resulting in better print registration and quality.

To load the printer 30, a ribbon roll leading edge may be pulled forward (arrow A in FIG. 2) along a ribbon path (arrow B in FIG. 2) above a stop sensor 46 of the print control assembly 36 and attached to the ribbon rewind spindle (with, for example, tape on the empty ribbon take 15). The ribbon rewind spindle 44 is rotated until the ribbon overlaps the ribbon leading edge and stretches tight. The media roll 20 is inserted onto the media supply spindle 42 and threaded through the printer along a media path (arrow C in FIG. 2). The printer further comprises one or more motors (not shown) for rotating the ribbon supply spindle 40 and the ribbon roll disposed thereon in a forward or a backward rotational direction (dependent on the ink surface), for rotating the media supply spindle 42 and the media roll disposed thereon in a forward rotational direction, and for rotating the ribbon rewind spindle 44. The stop sensor 46 is communicatively coupled to the processor (CPU) 35. The stop sensor 46 detects the presence of the print media in the printer before the thermal print head 31 and outputs an analog signal 68 representing the presence or absence of print media. In the absence of print media, the stop sensor 46 outputs the analog signal referred to herein as a “no print media sensor signal”.

The printer 30 further comprises a thermal print head 31 along the media path C utilized to thermally transfer a portion of ink from the ink ribbon to print media 22 as the ink ribbon is unwound from the ribbon core along the ribbon path B and the print media is unwound from the media core along the media path C. The printer 30 and control assembly 36 may have other components as known in the art.

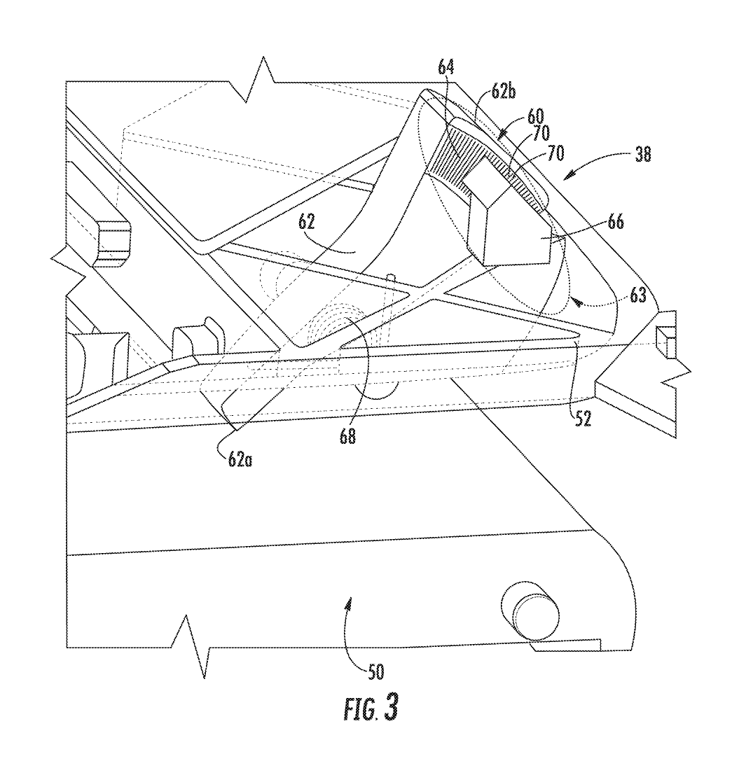

Referring again to FIGS. 1 through 3, in accordance with various embodiments, the printer further comprises the thickness detection module 38 (encircled region in FIG. 1) 38 disposed along the media path, prior to (aft of) the thermal print head 31. The thickness detection module 38 includes a support base 50. As depicted in FIG. 4, the support base 50 and a bracket 52 above the support base define a channel 54 for feeding and passing print media therethrough on its way along the media path C to the thermal print head 31. The channel 54 is a portion of the media path. The bracket 52 serves as an upper media guide and the support base 50 serves as a lower media guide.

Referring now to FIGS. 3 through 6B, in accordance with various embodiments of the present invention, the thickness detection module 38 comprises a pinch arm assembly (or simply “assembly”) comprising a pinch arm 62 including an encoder 64 proximate a dual channel encoder sensor 66. The encoder 64 may be a round flat plate (i.e., an encoder disk) or a radius strip as shown. The dual channel encoder sensor 66 is communicatively coupled to the processor 35 of printer 30. The pinch arm assembly 60 further comprises a biasing element, such as a torsion spring 68 as depicted in FIGS. 3 through 6B. The torsion spring 68 is mounted on the bracket 52 disposed above the support base. As noted previously, the bracket and spaced-apart support base define the channel 54 that forms a portion of the media path C (FIG. 2). The biasing element as exemplified by the torsion spring urges the pinch arm toward the support base and into engagement with at least a portion of the print media as hereinafter described.

The pinch arm 62 has a first end 62a and an opposite second end 62b, with the middle of the pinch arm being the pivot point. The first end 62a comprises a print media engagement end. The print media engagement end 62a engages with a top portion of at least a portion of the print media that is clamped between the print media engagement end and a top of the support base and disengages therefrom when the pinch arm is not engaged with at least a portion of the print media. The print media engagement end engages with the support base when there is no print media. The encoder 64 is disposed at the second end 62b of the pinch arm. The encoder 64 may be a separate component of the pinch arm assembly from the pinch arm and coupled to the second end 62b thereof or the encoder 64 may be integrally formed (one-piece) with the pinch arm 62. For example, the pinch arm 62 integrally formed with the encoder 64 has encoder markings as hereinafter described engraved into the second end of the pinch arm 62. In either case, rotation of the pinch arm comprises rotation of the encoder. The pinch arm has a length r (FIG. 4). The pinch arm extends radially from the support base, the pinch arm comprising an elongated substantially planar bar movably mounted on the bracket 52 for rotation with respect to the support base 50 as hereinafter described.

The encoder 64 is patterned with a single track of repeating identical lines 70 (i.e., “encoder markings”) near an outside edge of the encoder (a series of circumferentially spaced lines and line pairs). The encoder has an encoder sensing radius R (FIG. 4). The lines 70 are dispersed radially about an axis of the encoder 64. The number of line pairs on the encoder 64 determines the encoder resolution (Cycles Per Revolution (CPR)), for example, the number of full quadrature cycles per revolution. A revolution comprises 360 mechanical degrees. The encoder resolution and thus the thickness detection resolution will increase as the CPR increases; however, printer stability is at risk if the CPR is too high. As hereinafter described, in accordance with various embodiments of the present invention, an encoder 64 with fine lines (greater than about 2000 Cycles Per Revolution (CPR)) may be used to detect print media thickness with sufficient resolution.

The dual channel encoder sensor 66 of the pinch assembly 60 detects and counts the line pairs as the lines of the encoder pass the dual channel encoder sensor 66 during rotation of the pinch arm and encoder as hereinafter described. The dual channel encoder sensor 66 of the pinch assembly 60 also detects rotation direction of the pinch arm and encoder. The number (n) of line pairs detected and counted over “a time interval” as the lines pass the dual channel encoder sensor during rotation of the pinch arm and encoder is used to determine an encoder count (i.e., the number of line pairs of the encoder that pass the dual channel encoder sensor during rotation of the pinch arm and encoder.) The encoder count is converted into a print media thickness using a conversion factor as hereinafter described. The time interval is the time in which the pinch arm and encoder rotate in one direction. As hereinafter described, the pinch arm and encoder change rotation direction when the print media thickness changes. Therefore, the encoder count is the number of line pairs that are counted until the print media thickness changes and the rotation direction reverses.

The dual channel encoder sensor detects and counts the line pairs of encoder lines 70 and rotation direction of the pinch arm and encoder as the first end of the pinch arm is engaged with the print media. The dual channel encoder sensor is configured to output at least one signal representing the rotation direction and the number of line pairs of the rotating encoder that pass the proximate dual channel encoder sensor during the time interval.

The encoder count is zero when there is no rotation of the pinch arm and encoder as the rotation is a result of displacement of the pinch arm by print media as hereinafter described. If there is no print media engaged by the pinch arm (more specifically, by the print media engagement end of the pinch arm), there is no rotation and the encoder count is zero.

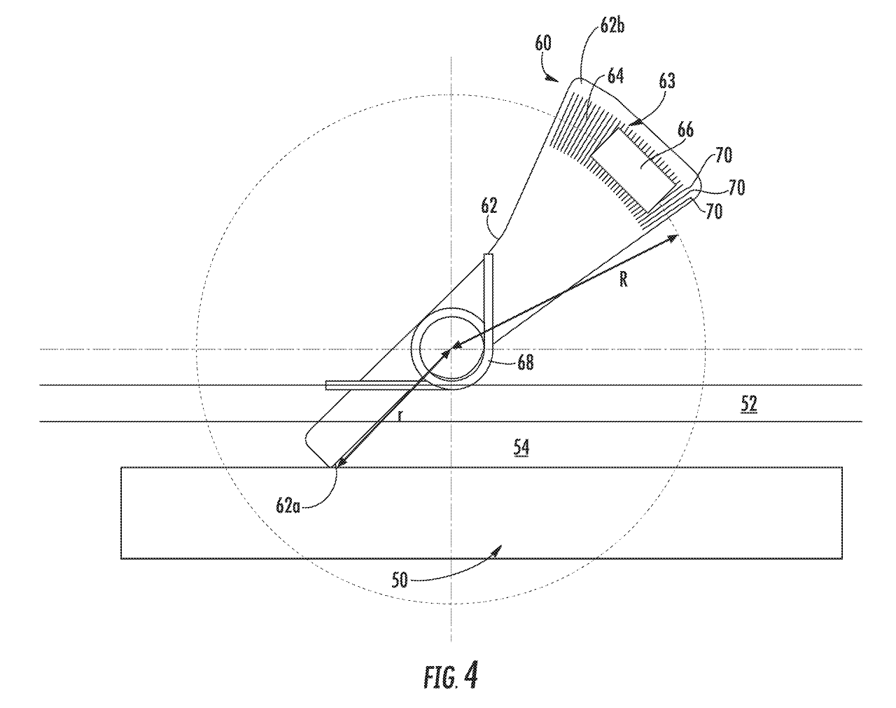

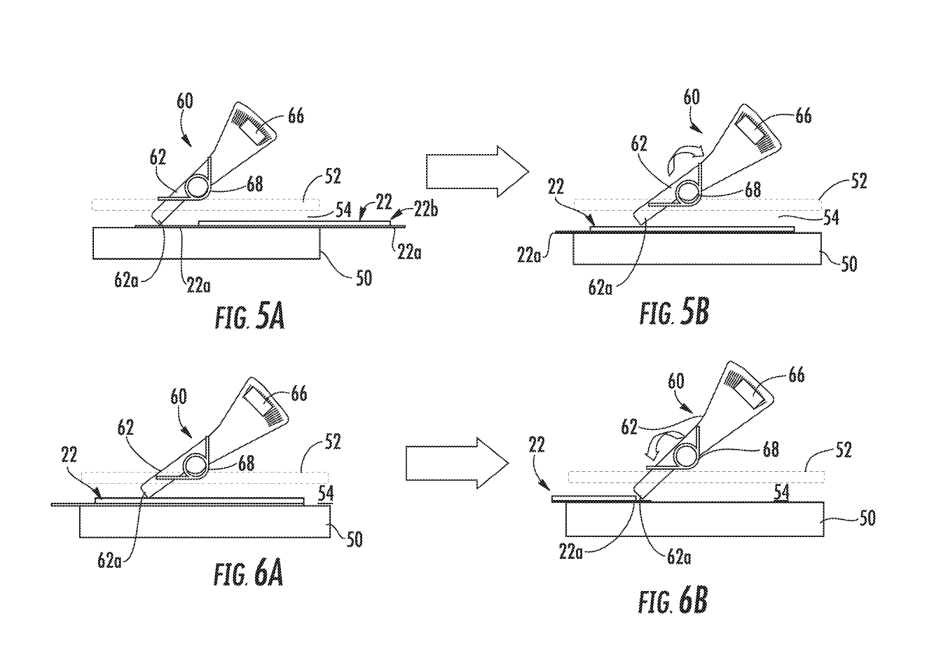

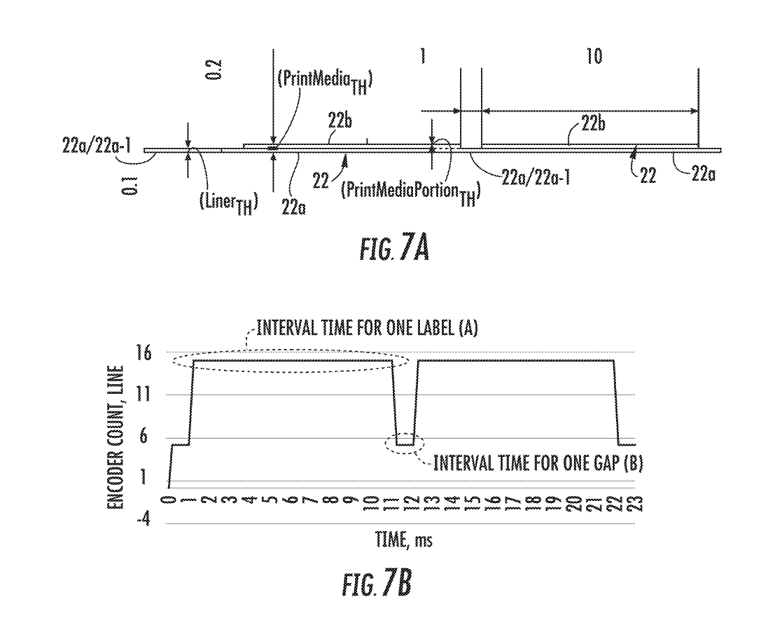

Referring now to FIGS. 5A through 5B and 6A through 6B, according to various embodiments of the present invention, when the print media 22 travels along the media path in FIG. 2) on the way to the thermal print head 31, the print media 22 passes through the channel 54 between the support base 50 and the bracket 52. When a least a portion of the print media moves under the first end 62a of the pinch arm 62 disposed above the support base 50, the print media exerts a moving force on the pinch arm 62, with the help of the biasing element such as torsion spring 68, thereby displacing the pinch arm into engagement with at least the portion of the print media. The pinch arm 62 is displaced at a different angle of rotation as reflected in the encoder count depending upon the print media thickness. The pinch arm 62 is displaced at a greater angle of rotation (a higher encoder count) as the print media thickness increases. The biasing element, such as torsion spring 68, presses the first end of the pinch arm as low as possible before the print media is fed through the channel 54. Once the print media is fed through the channel 54, the pinch arm rotates a certain amount and the amount of rotation translates to the print media thickness. The encoder count is therefore the difference in encoder counts before and after feeding the print media through the channel.

FIGS. 5A and 5B, according to various embodiments of the present invention, depict clockwise rotation of the pinch arm from a first position (FIG. 5A) in which the print media engagement end (the first end 62a) of the pinch arm is engaged with the liner only portion 22a-1 (FIG. 7A) of the print media (i.e., “thin” print media) passing through the channel 54 between the support base and the bracket of the thickness detection module (FIGS. 1 and 2) to a second position in which the print media engagement end (first end 62a) of the pinch arm is engaged with a thicker portion of the print media (the print medium portion 22b and an underlying liner portion 22a) (“thick” print media) (FIG. 7A) (a so-called “thin to thick embodiment”). The print media 22 passes through the channel toward the thermal print head 31.

In accordance with various embodiments, FIGS. 6A and 6B graphically depict counterclockwise rotation of the pinch arm from a first position (FIG. 6A) in which the first end of the pinch arm is engaged with the thick print media (the print medium portion and an underlying liner portion) passing through the channel to a second position in which the first end of the print media is engaged with the liner only portion of the print media (i.e., thin print media), with the encoder count decreasing as the print media thickness decreases and the rotation direction of the pinch arm changing in response to a change in the print media thickness according to various embodiments (a so-called “thick to thin embodiment”). The print media 22 passes through the channel along the media path (C in FIG. 2) toward the thermal print head 31. Thus, the dual channel encoder sensor detects the relative movement of the pinch arm and encoder before and after the print media is loaded into the printer.

Still referring to FIGS. 5A through 5B and 6A through 6B, and now to FIGS. 7A and 7B, according to various embodiments of the present invention, the encoder count and the rotation direction changes as the print media thickness changes. The encoder count is lower (5 in the depicted embodiment) when the first end of the pinch arm is engaged with the liner only (thin) portion 22a/22a-1 of the print media (FIGS. 5A and 6B). As shown in FIG. 7B, the first end of the pinch arm is engaged with the liner only portion of the print media for one milliseconds (ms) (the “time interval”). The encoder count is higher (15 in the depicted embodiment) when the first end of the pinch arm is engaged with the thicker print media 22 (inclusive of liner portion 22a and print media portion 22b) (FIGS. 5B and 6A). As shown in FIG. 7B, the first end of the pinch arm is engaged with the thicker print media (encoder count at highest value) for an exemplary 10 milliseconds (ms) (a “time interval”).

According to various embodiments, the length of the label, as well as the gap length and pitch between labels can be determined using the method according to various embodiments. The velocity (print speed) of the moving label is known by the printer. The time interval (e.g., 10 milliseconds in the depicted embodiment of FIG. 7B) in which the first end of the pinch arm is engaged with the thicker print media is an interval time for one label (encircled region A in FIG. 7B). The gap length between labels is depicted as encircled region B in FIG. 7B as “Interval Time for one gap” which is the interval time of encoder count at the lowest value. According to various embodiments:

Label length=Interval time for one label×velocity;

Gap length between labels=Interval time for one gap×velocity;

Label pitch=Label length+Gap length.

Referring now to FIG. 8, according to various embodiments, a method 10 for detecting a print media thickness of the print media in a printer comprises setting the encoder count to zero (step 100). Prior to setting the encoder count to zero, the user may be prompted to remove the print media from the printer. The processor sets the encoder count to zero when the processor 35 receives a stop sensor signal from the stop sensor (46 in FIG. 2) that no print media is present, i.e., receives a no print media sensor signal.

Still referring to FIG. 8, according to various embodiments, the method 10 for detecting the print media thickness comprises receiving a signal from the dual channel encoder sensor, the signal representing the rotation direction and the number of line pairs that, during the time interval, pass by the dual channel encoder sensor as the pinch arm and encoder rotate (i.e., the encoder count) (step 110). The thickness of the print media is detected by counting the relative movement of the pinch arm before and after the print media is inserted into the printer. As noted previously, the encoder count is set to zero before feeding the print media into the channel. As the print media 22 passes through the channel in the thickness detection module, and more specifically between the first end of the pinch arm and the support base, the pinch arm rotates at a different angle of rotation depending upon the print media thickness. The encoder count also differs depending upon the print media thickness, i.e., the number of encoder line pairs that pass the dual channel encoder sensor differs depending upon the print media thickness. As the print media thickness increases, the encoder count increases. As the print media thickness decreases, the encoder count decreases. Thus, if the first end of the pinch arm engages with the liner only portion of the print media (for example, in the gap between (thicker) individual medium), the encoder count will be less than the encoder count when the first end of the pinch arm engages with the thicker portion of the print medium (e.g., a label and the underlying liner).

The accuracy of the calculated print media thickness depends upon the encoder sensing radius R/pinch arm length r ratio (FIG. 4) and the encoder CPR. The accuracy may be increased by increasing the ratio and/or by increasing the CPR number of the encoder. For example, a 0.1 mm resolution may be achieved with a 2000 CPR encoder. A 0.05 mm resolution and a 0.02 mm resolution may be achieved with a 5000 CPR encoder. However, increasing the thickness detection resolution too much may increase sensitivity of the printer toward jerk and vibration. Therefore, increasing the accuracy of the calculated print media thickness requires a balance between resolution improvement and printer stability.

Still referring to FIG. 8, according to various embodiments of the present invention, the method 10 for detecting a print media thickness of the print media comprises, in response to receiving the at least one signal from the dual channel encoder sensor, calculating the print media thickness from the encoder count by using the conversion factor (step 120). As noted previously, the conversion factor is used by the processor 35 to calculate the print media thickness from the encoder count. For the conversion of the exemplary encoder counts depicted in FIG. 7B, the exemplary conversion factor comprises an encoder count of 5 being equal to a print media thickness of 0.1 mm as noted previously. Of course, the conversion factor may be other than this and may be determined by encoder resolution, i.e., by the pinch arm length r and encoder sensing radius R.

Therefore, as described previously, in the example provided in FIGS. 5A through 5B and FIGS. 6A through 6B, the encoder count changes from zero (no print media between the first end of the pinch arm and the support base), to an encoder count of 5 when the liner only portion 22a/22a-1 is engaged between the first end of the pinch arm and the support base (i.e., FIGS. 5A and 6B), to an encoder count of 15 when the print media 22 (inclusive of the liner portion 22a underlying the individual print medium portion (e.g., a label) is engaged between the first end of the pinch arm and the support base (FIGS. 5B and 6A). Using the exemplary conversion factor as discussed above, the processor 35 calculates from the encoder count of 5 (FIG. 7B) that the liner portion of the print media has a 0.1 mm liner thickness (an exemplary print media thickness) and from the encoder count of 15 that the print media comprising the liner portion underlying the print medium portion is 0.3 mm thick (an exemplary print media thickness). The processor may calculate the print medium portion thickness by subtracting the liner thickness from the total thickness, making the label 0.2 mm thick (0.3 mm-0.1 mm) in the depicted embodiment of FIG. 7A.

Once the print media thickness is calculated, the TPH pressure may be adjusted to the optimal TPH pressure for the calculated print media thickness (the print job), resulting in better print registration and print quality. The TPH pressure is adjusted in a well-known manner (i.e., Firmware control motor system may be used to change TPH pressure).

To supplement the present disclosure, this application incorporates entirely by reference the following commonly assigned patents, patent application publications, and patent applications:
U.S. Pat. No. 6,832,725; U.S. Pat. No. 7,128,266;
U.S. Pat. No. 7,159,783; U.S. Pat. No. 7,413,127;
U.S. Pat. No. 7,726,575; U.S. Pat. No. 8,294,969;
U.S. Pat. No. 8,317,105; U.S. Pat. No. 8,322,622;
U.S. Pat. No. 8,366,005; U.S. Pat. No. 8,371,507;
U.S. Pat. No. 8,376,233; U.S. Pat. No. 8,381,979;
U.S. Pat. No. 8,390,909; U.S. Pat. No. 8,408,464;
U.S. Pat. No. 8,408,468; U.S. Pat. No. 8,408,469;
U.S. Pat. No. 8,424,768; U.S. Pat. No. 8,448,863;
U.S. Pat. No. 8,457,013; U.S. Pat. No. 8,459,557;
U.S. Pat. No. 8,469,272; U.S. Pat. No. 8,474,712;
U.S. Pat. No. 8,479,992; U.S. Pat. No. 8,490,877;
U.S. Pat. No. 8,517,271; U.S. Pat. No. 8,523,076;
U.S. Pat. No. 8,528,818; U.S. Pat. No. 8,544,737;
U.S. Pat. No. 8,548,242; U.S. Pat. No. 8,548,420;
U.S. Pat. No. 8,550,335; U.S. Pat. No. 8,550,354;
U.S. Pat. No. 8,550,357; U.S. Pat. No. 8,556,174;
U.S. Pat. No. 8,556,176; U.S. Pat. No. 8,556,177;
U.S. Pat. No. 8,559,767; U.S. Pat. No. 8,599,957;
U.S. Pat. No. 8,561,895; U.S. Pat. No. 8,561,903;
U.S. Pat. No. 8,561,905; U.S. Pat. No. 8,565,107;
U.S. Pat. No. 8,571,307; U.S. Pat. No. 8,579,200;
U.S. Pat. No. 8,583,924; U.S. Pat. No. 8,584,945;
U.S. Pat. No. 8,587,595; U.S. Pat. No. 8,587,697;
U.S. Pat. No. 8,588,869; U.S. Pat. No. 8,590,789;
U.S. Pat. No. 8,596,539; U.S. Pat. No. 8,596,542;
U.S. Pat. No. 8,596,543; U.S. Pat. No. 8,599,271;
U.S. Pat. No. 8,599,957; U.S. Pat. No. 8,600,158;
U.S. Pat. No. 8,600,167; U.S. Pat. No. 8,602,309;
U.S. Pat. No. 8,608,053; U.S. Pat. No. 8,608,071;
U.S. Pat. No. 8,611,309; U.S. Pat. No. 8,615,487;
U.S. Pat. No. 8,616,454; U.S. Pat. No. 8,621,123;
U.S. Pat. No. 8,622,303; U.S. Pat. No. 8,628,013;
U.S. Pat. No. 8,628,015; U.S. Pat. No. 8,628,016;
U.S. Pat. No. 8,629,926; U.S. Pat. No. 8,630,491;
U.S. Pat. No. 8,635,309; U.S. Pat. No. 8,636,200;
U.S. Pat. No. 8,636,212; U.S. Pat. No. 8,636,215;
U.S. Pat. No. 8,636,224; U.S. Pat. No. 8,638,806;
U.S. Pat. No. 8,640,958; U.S. Pat. No. 8,640,960;
U.S. Pat. No. 8,643,717; U.S. Pat. No. 8,646,692;
U.S. Pat. No. 8,646,694; U.S. Pat. No. 8,657,200;
U.S. Pat. No. 8,659,397; U.S. Pat. No. 8,668,149;
U.S. Pat. No. 8,678,285; U.S. Pat. No. 8,678,286;
U.S. Pat. No. 8,682,077; U.S. Pat. No. 8,687,282;
U.S. Pat. No. 8,692,927; U.S. Pat. No. 8,695,880;
U.S. Pat. No. 8,698,949; U.S. Pat. No. 8,717,494;
U.S. Pat. No. 8,717,494; U.S. Pat. No. 8,720,783;
U.S. Pat. No. 8,723,804; U.S. Pat. No. 8,723,904;
U.S. Pat. No. 8,727,223; U.S. Pat. No. D702,237;
U.S. Pat. No. 8,740,082; U.S. Pat. No. 8,740,085;
U.S. Pat. No. 8,746,563; U.S. Pat. No. 8,750,445;
U.S. Pat. No. 8,752,766; U.S. Pat. No. 8,756,059;
U.S. Pat. No. 8,757,495; U.S. Pat. No. 8,760,563;
U.S. Pat. No. 8,763,909; U.S. Pat. No. 8,777,108;
U.S. Pat. No. 8,777,109; U.S. Pat. No. 8,779,898;
U.S. Pat. No. 8,781,520; U.S. Pat. No. 8,783,573;
U.S. Pat. No. 8,789,757; U.S. Pat. No. 8,789,758;
U.S. Pat. No. 8,789,759; U.S. Pat. No. 8,794,520;
U.S. Pat. No. 8,794,522; U.S. Pat. No. 8,794,525;
U.S. Pat. No. 8,794,526; U.S. Pat. No. 8,798,367;
U.S. Pat. No. 8,807,431; U.S. Pat. No. 8,807,432;
U.S. Pat. No. 8,820,630; U.S. Pat. No. 8,822,848;
U.S. Pat. No. 8,824,692; U.S. Pat. No. 8,824,696;
U.S. Pat. No. 8,842,849; U.S. Pat. No. 8,844,822;
U.S. Pat. No. 8,844,823; U.S. Pat. No. 8,849,019;
U.S. Pat. No. 8,851,383; U.S. Pat. No. 8,854,633;
U.S. Pat. No. 8,866,963; U.S. Pat. No. 8,868,421;
U.S. Pat. No. 8,868,519; U.S. Pat. No. 8,868,802;
U.S. Pat. No. 8,868,803; U.S. Pat. No. 8,870,074;
U.S. Pat. No. 8,879,639; U.S. Pat. No. 8,880,426;
U.S. Pat. No. 8,881,983; U.S. Pat. No. 8,881,987;
U.S. Pat. No. 8,903,172; U.S. Pat. No. 8,908,995;
U.S. Pat. No. 8,910,870; U.S. Pat. No. 8,910,875;
U.S. Pat. No. 8,914,290; U.S. Pat. No. 8,914,788;
U.S. Pat. No. 8,915,439; U.S. Pat. No. 8,915,444;
U.S. Pat. No. 8,916,789; U.S. Pat. No. 8,918,250;
U.S. Pat. No. 8,918,564; U.S. Pat. No. 8,925,818;
U.S. Pat. No. 8,939,374; U.S. Pat. No. 8,942,480;
U.S. Pat. No. 8,944,313; U.S. Pat. No. 8,944,327;
U.S. Pat. No. 8,944,332; U.S. Pat. No. 8,950,678;
U.S. Pat. No. 8,967,468; U.S. Pat. No. 8,971,346;
U.S. Pat. No. 8,976,030; U.S. Pat. No. 8,976,368;
U.S. Pat. No. 8,978,981; U.S. Pat. No. 8,978,983;
U.S. Pat. No. 8,978,984; U.S. Pat. No. 8,985,456;
U.S. Pat. No. 8,985,457; U.S. Pat. No. 8,985,459;
U.S. Pat. No. 8,985,461; U.S. Pat. No. 8,988,578;
U.S. Pat. No. 8,988,590; U.S. Pat. No. 8,991,704;
U.S. Pat. No. 8,996,194; U.S. Pat. No. 8,996,384;
U.S. Pat. No. 9,002,641; U.S. Pat. No. 9,007,368;
U.S. Pat. No. 9,010,641; U.S. Pat. No. 9,015,513;
U.S. Pat. No. 9,016,576; U.S. Pat. No. 9,022,288;
U.S. Pat. No. 9,030,964; U.S. Pat. No. 9,033,240;
U.S. Pat. No. 9,033,242; U.S. Pat. No. 9,036,054;
U.S. Pat. No. 9,037,344; U.S. Pat. No. 9,038,911;
U.S. Pat. No. 9,038,915; U.S. Pat. No. 9,047,098;
U.S. Pat. No. 9,047,359; U.S. Pat. No. 9,047,420;
U.S. Pat. No. 9,047,525; U.S. Pat. No. 9,047,531;
U.S. Pat. No. 9,053,055; U.S. Pat. No. 9,053,378;
U.S. Pat. No. 9,053,380; U.S. Pat. No. 9,058,526;
U.S. Pat. No. 9,064,165; U.S. Pat. No. 9,064,167;
U.S. Pat. No. 9,064,168; U.S. Pat. No. 9,064,254;
U.S. Pat. No. 9,066,032; U.S. Pat. No. 9,070,032;
U.S. Design Pat. No. D716,285;
U.S. Design Pat. No. D723,560;
U.S. Design Pat. No. D730,357;
U.S. Design Pat. No. D730,901;
U.S. Design Pat. No. D730,902;
U.S. Design Pat. No. D733,112;
U.S. Design Pat. No. D734,339;
International Publication No. 2013/163789;
International Publication No. 2013/173985;
International Publication No. 2014/019130;
International Publication No. 2014/110495;
U.S. Patent Application Publication No. 2008/0185432;
U.S. Patent Application Publication No. 2009/0134221;
U.S. Patent Application Publication No. 2010/0177080;
U.S. Patent Application Publication No. 2010/0177076;
U.S. Patent Application Publication No. 2010/0177707;
U.S. Patent Application Publication No. 2010/0177749;
U.S. Patent Application Publication No. 2010/0265880;
U.S. Patent Application Publication No. 2011/0202554;
U.S. Patent Application Publication No. 2012/0111946;
U.S. Patent Application Publication No. 2012/0168511;
U.S. Patent Application Publication No. 2012/0168512;
U.S. Patent Application Publication No. 2012/0193423;
U.S. Patent Application Publication No. 2012/0203647;
U.S. Patent Application Publication No. 2012/0223141;
U.S. Patent Application Publication No. 2012/0228382;
U.S. Patent Application Publication No. 2012/0248188;
U.S. Patent Application Publication No. 2013/0043312;
U.S. Patent Application Publication No. 2013/0082104;
U.S. Patent Application Publication No. 2013/0175341;
U.S. Patent Application Publication No. 2013/0175343;
U.S. Patent Application Publication No. 2013/0257744;
U.S. Patent Application Publication No. 2013/0257759;
U.S. Patent Application Publication No. 2013/0270346;
U.S. Patent Application Publication No. 2013/0287258;
U.S. Patent Application Publication No. 2013/0292475;
U.S. Patent Application Publication No. 2013/0292477;
U.S. Patent Application Publication No. 2013/0293539;
U.S. Patent Application Publication No. 2013/0293540;
U.S. Patent Application Publication No. 2013/0306728;
U.S. Patent Application Publication No. 2013/0306731;
U.S. Patent Application Publication No. 2013/0307964;
U.S. Patent Application Publication No. 2013/0308625;
U.S. Patent Application Publication No. 2013/0313324;
U.S. Patent Application Publication No. 2013/0313325;
U.S. Patent Application Publication No. 2013/0342717;
U.S. Patent Application Publication No. 2014/0001267;
U.S. Patent Application Publication No. 2014/0008439;
U.S. Patent Application Publication No. 2014/0025584;
U.S. Patent Application Publication No. 2014/0034734;
U.S. Patent Application Publication No. 2014/0036848;
U.S. Patent Application Publication No. 2014/0039693;
U.S. Patent Application Publication No. 2014/0042814;
U.S. Patent Application Publication No. 2014/0049120;
U.S. Patent Application Publication No. 2014/0049635;
U.S. Patent Application Publication No. 2014/0061306;
U.S. Patent Application Publication No. 2014/0063289;
U.S. Patent Application Publication No. 2014/0066136;
U.S. Patent Application Publication No. 2014/0067692;
U.S. Patent Application Publication No. 2014/0070005;
U.S. Patent Application Publication No. 2014/0071840;
U.S. Patent Application Publication No. 2014/0074746;
U.S. Patent Application Publication No. 2014/0076974;
U.S. Patent Application Publication No. 2014/0078341;
U.S. Patent Application Publication No. 2014/0078345;
U.S. Patent Application Publication No. 2014/0097249;
U.S. Patent Application Publication No. 2014/0098792;
U.S. Patent Application Publication No. 2014/0100813;
U.S. Patent Application Publication No. 2014/0103115;
U.S. Patent Application Publication No. 2014/0104413;
U.S. Patent Application Publication No. 2014/0104414;
U.S. Patent Application Publication No. 2014/0104416;
U.S. Patent Application Publication No. 2014/0104451;
U.S. Patent Application Publication No. 2014/0106594;
U.S. Patent Application Publication No. 2014/0106725;
U.S. Patent Application Publication No. 2014/0108010;
U.S. Patent Application Publication No. 2014/0108402;
U.S. Patent Application Publication No. 2014/0110485;
U.S. Patent Application Publication No. 2014/0114530;
U.S. Patent Application Publication No. 2014/0124577;
U.S. Patent Application Publication No. 2014/0124579;
U.S. Patent Application Publication No. 2014/0125842;
U.S. Patent Application Publication No. 2014/0125853;
U.S. Patent Application Publication No. 2014/0125999;
U.S. Patent Application Publication No. 2014/0129378;
U.S. Patent Application Publication No. 2014/0131438;
U.S. Patent Application Publication No. 2014/0131441;
U.S. Patent Application Publication No. 2014/0131443;
U.S. Patent Application Publication No. 2014/0131444;
U.S. Patent Application Publication No. 2014/0131445;
U.S. Patent Application Publication No. 2014/0131448;
U.S. Patent Application Publication No. 2014/0133379;
U.S. Patent Application Publication No. 2014/0136208;
U.S. Patent Application Publication No. 2014/0140585;
U.S. Patent Application Publication No. 2014/0151453;
U.S. Patent Application Publication No. 2014/0152882;
U.S. Patent Application Publication No. 2014/0158770;
U.S. Patent Application Publication No. 2014/0159869;
U.S. Patent Application Publication No. 2014/0166755;
U.S. Patent Application Publication No. 2014/0166759;
U.S. Patent Application Publication No. 2014/0168787;
U.S. Patent Application Publication No. 2014/0175165;
U.S. Patent Application Publication No. 2014/0175172;
U.S. Patent Application Publication No. 2014/0191644;
U.S. Patent Application Publication No. 2014/0191913;
U.S. Patent Application Publication No. 2014/0197238;
U.S. Patent Application Publication No. 2014/0197239;
U.S. Patent Application Publication No. 2014/0197304;
U.S. Patent Application Publication No. 2014/0214631;
U.S. Patent Application Publication No. 2014/0217166;
U.S. Patent Application Publication No. 2014/0217180;
U.S. Patent Application Publication No. 2014/0231500;
U.S. Patent Application Publication No. 2014/0232930;
U.S. Patent Application Publication No. 2014/0247315;
U.S. Patent Application Publication No. 2014/0263493;
U.S. Patent Application Publication No. 2014/0263645;
U.S. Patent Application Publication No. 2014/0267609;
U.S. Patent Application Publication No. 2014/0270196;
U.S. Patent Application Publication No. 2014/0270229;
U.S. Patent Application Publication No. 2014/0278387;
U.S. Patent Application Publication No. 2014/0278391;
U.S. Patent Application Publication No. 2014/0282210;
U.S. Patent Application Publication No. 2014/0284384;
U.S. Patent Application Publication No. 2014/0288933;
U.S. Patent Application Publication No. 2014/0297058;
U.S. Patent Application Publication No. 2014/0299665;
U.S. Patent Application Publication No. 2014/0312121;
U.S. Patent Application Publication No. 2014/0319220;
U.S. Patent Application Publication No. 2014/0319221;
U.S. Patent Application Publication No. 2014/0326787;
U.S. Patent Application Publication No. 2014/0332590;
U.S. Patent Application Publication No. 2014/0344943;
U.S. Patent Application Publication No. 2014/0346233;
U.S. Patent Application Publication No. 2014/0351317;
U.S. Patent Application Publication No. 2014/0353373;
U.S. Patent Application Publication No. 2014/0361073;
U.S. Patent Application Publication No. 2014/0361082;
U.S. Patent Application Publication No. 2014/0362184;
U.S. Patent Application Publication No. 2014/0363015;
U.S. Patent Application Publication No. 2014/0369511;
U.S. Patent Application Publication No. 2014/0374483;
U.S. Patent Application Publication No. 2014/0374485;
U.S. Patent Application Publication No. 2015/0001301;
U.S. Patent Application Publication No. 2015/0001304;
U.S. Patent Application Publication No. 2015/0003673;
U.S. Patent Application Publication No. 2015/0009338;
U.S. Patent Application Publication No. 2015/0009610;
U.S. Patent Application Publication No. 2015/0014416;
U.S. Patent Application Publication No. 2015/0021397;
U.S. Patent Application Publication No. 2015/0028102;
U.S. Patent Application Publication No. 2015/0028103;
U.S. Patent Application Publication No. 2015/0028104;
U.S. Patent Application Publication No. 2015/0029002;
U.S. Patent Application Publication No. 2015/0032709;
U.S. Patent Application Publication No. 2015/0039309;
U.S. Patent Application Publication No. 2015/0039878;
U.S. Patent Application Publication No. 2015/0040378;
U.S. Patent Application Publication No. 2015/0048168;
U.S. Patent Application Publication No. 2015/0049347;
U.S. Patent Application Publication No. 2015/0051992;
U.S. Patent Application Publication No. 2015/0053766;
U.S. Patent Application Publication No. 2015/0053768;
U.S. Patent Application Publication No. 2015/0053769;
U.S. Patent Application Publication No. 2015/0060544;
U.S. Patent Application Publication No. 2015/0062366;
U.S. Patent Application Publication No. 2015/0063215;
U.S. Patent Application Publication No. 2015/0063676;
U.S. Patent Application Publication No. 2015/0069130;
U.S. Patent Application Publication No. 2015/0071819;
U.S. Patent Application Publication No. 2015/0083800;
U.S. Patent Application Publication No. 2015/0086114;
U.S. Patent Application Publication No. 2015/0088522;
U.S. Patent Application Publication No. 2015/0096872;
U.S. Patent Application Publication No. 2015/0099557;
U.S. Patent Application Publication No. 2015/0100196;
U.S. Patent Application Publication No. 2015/0102109;
U.S. Patent Application Publication No. 2015/0115035;
U.S. Patent Application Publication No. 2015/0127791;
U.S. Patent Application Publication No. 2015/0128116;
U.S. Patent Application Publication No. 2015/0129659;
U.S. Patent Application Publication No. 2015/0133047;
U.S. Patent Application Publication No. 2015/0134470;
U.S. Patent Application Publication No. 2015/0136851;
U.S. Patent Application Publication No. 2015/0136854;
U.S. Patent Application Publication No. 2015/0142492;
U.S. Patent Application Publication No. 2015/0144692;
U.S. Patent Application Publication No. 2015/0144698;
U.S. Patent Application Publication No. 2015/0144701;
U.S. Patent Application Publication No. 2015/0149946;
U.S. Patent Application Publication No. 2015/0161429;
U.S. Patent Application Publication No. 2015/0169925;
U.S. Patent Application Publication No. 2015/0169929;
U.S. Patent Application Publication No. 2015/0178523;
U.S. Patent Application Publication No. 2015/0178534;
U.S. Patent Application Publication No. 2015/0178535;
U.S. Patent Application Publication No. 2015/0178536;
U.S. Patent Application Publication No. 2015/0178537;
U.S. Patent Application Publication No. 2015/0181093;
U.S. Patent Application Publication No. 2015/0181109;
U.S. patent application Ser. No. 13/367,978 for a Laser Scanning Module Employing an Elastomeric U-Hinge Based Laser Scanning Assembly, filed Feb. 7, 2012 (Feng et al.);
U.S. patent application Ser. No. 29/458,405 for an Electronic Device, filed Jun. 19, 2013 (Fitch et al.);
U.S. patent application Ser. No. 29/459,620 for an Electronic Device Enclosure, filed Jul. 2, 2013 (London et al.);
U.S. patent application Ser. No. 29/468,118 for an Electronic Device Case, filed Sep. 26, 2013 (Oberpriller et al.);
U.S. patent application Ser. No. 14/150,393 for Indicia-reader Having Unitary Construction Scanner, filed Jan. 8, 2014 (Colavito et al.);
U.S. patent application Ser. No. 14/200,405 for Indicia Reader for Size-Limited Applications filed Mar. 7, 2014 (Feng et al.);
U.S. patent application Ser. No. 14/231,898 for Hand-Mounted Indicia-Reading Device with Finger Motion Triggering filed Apr. 1, 2014 (Van Horn et al.);
U.S. patent application Ser. No. 29/486,759 for an Imaging Terminal, filed Apr. 2, 2014 (Oberpriller et al.);
U.S. patent application Ser. No. 14/257,364 for Docking System and Method Using Near Field Communication filed Apr. 21, 2014 (Showering);
U.S. patent application Ser. No. 14/264,173 for Autofocus Lens System for Indicia Readers filed Apr. 29, 2014 (Ackley et al.);
U.S. patent application Ser. No. 14/277,337 for MULTIPURPOSE OPTICAL READER, filed May 14, 2014 (Jovanovski et al.);
U.S. patent application Ser. No. 14/283,282 for TERMINAL HAVING ILLUMINATION AND FOCUS CONTROL filed May 21, 2014 (Liu et al.);
U.S. patent application Ser. No. 14/327,827 for a MOBILE-PHONE ADAPTER FOR ELECTRONIC TRANSACTIONS, filed Jul. 10, 2014 (Hejl);
U.S. patent application Ser. No. 14/334,934 for a SYSTEM AND METHOD FOR INDICIA VERIFICATION, filed Jul. 18, 2014 (Hejl);
U.S. patent application Ser. No. 14/339,708 for LASER SCANNING CODE SYMBOL READING SYSTEM, filed Jul. 24, 2014 (Xian et al.);
U.S. patent application Ser. No. 14/340,627 for an AXIALLY REINFORCED FLEXIBLE SCAN ELEMENT, filed Jul. 25, 2014 (Rueblinger et al.);
U.S. patent application Ser. No. 14/446,391 for MULTIFUNCTION POINT OF SALE APPARATUS WITH OPTICAL SIGNATURE CAPTURE filed Jul. 30, 2014 (Good et al.);
U.S. patent application Ser. No. 14/452,697 for INTERACTIVE INDICIA READER, filed Aug. 6, 2014 (Todeschini);
U.S. patent application Ser. No. 14/453,019 for DIMENSIONING SYSTEM WITH GUIDED ALIGNMENT, filed Aug. 6, 2014 (Li et al.);
U.S. patent application Ser. No. 14/462,801 for MOBILE COMPUTING DEVICE WITH DATA COGNITION SOFTWARE, filed on Aug. 19, 2014 (Todeschini et al.);
U.S. patent application Ser. No. 14/483,056 for VARIABLE DEPTH OF FIELD BARCODE SCANNER filed Sep. 10, 2014 (McCloskey et al.);
U.S. patent application Ser. No. 14/513,808 for IDENTIFYING INVENTORY ITEMS IN A STORAGE FACILITY filed Oct. 14, 2014 (Singel et al.);
U.S. patent application Ser. No. 14/519,195 for HANDHELD DIMENSIONING SYSTEM WITH FEEDBACK filed Oct. 21, 2014 (Laffargue et al.);
U.S. patent application Ser. No. 14/519,179 for DIMENSIONING SYSTEM WITH MULTIPATH INTERFERENCE MITIGATION filed Oct. 21, 2014 (Thuries et al.);
U.S. patent application Ser. No. 14/519,211 for SYSTEM AND METHOD FOR DIMENSIONING filed Oct. 21, 2014 (Ackley et al.);
U.S. patent application Ser. No. 14/519,233 for HANDHELD DIMENSIONER WITH DATA-QUALITY INDICATION filed Oct. 21, 2014 (Laffargue et al.);
U.S. patent application Ser. No. 14/519,249 for HANDHELD DIMENSIONING SYSTEM WITH MEASUREMENT-CONFORMANCE FEEDBACK filed Oct. 21, 2014 (Ackley et al.);
U.S. patent application Ser. No. 14/527,191 for METHOD AND SYSTEM FOR RECOGNIZING SPEECH USING WILDCARDS IN AN EXPECTED RESPONSE filed Oct. 29, 2014 (Braho et al.);
U.S. patent application Ser. No. 14/529,563 for ADAPTABLE INTERFACE FOR A MOBILE COMPUTING DEVICE filed Oct. 31, 2014 (Schoon et al.);
U.S. patent application Ser. No. 14/529,857 for BARCODE READER WITH SECURITY FEATURES filed Oct. 31, 2014 (Todeschini et al.);
U.S. patent application Ser. No. 14/398,542 for PORTABLE ELECTRONIC DEVICES HAVING A SEPARATE LOCATION TRIGGER UNIT FOR USE IN CONTROLLING AN APPLICATION UNIT filed Nov. 3, 2014 (Bian et al.);
U.S. patent application Ser. No. 14/531,154 for DIRECTING AN INSPECTOR THROUGH AN INSPECTION filed Nov. 3, 2014 (Miller et al.);
U.S. patent application Ser. No. 14/533,319 for BARCODE SCANNING SYSTEM USING WEARABLE DEVICE WITH EMBEDDED CAMERA filed Nov. 5, 2014 (Todeschini);
U.S. patent application Ser. No. 14/535,764 for CONCATENATED EXPECTED RESPONSES FOR SPEECH RECOGNITION filed Nov. 7, 2014 (Braho et al.);
U.S. patent application Ser. No. 14/568,305 for AUTO-CONTRAST VIEWFINDER FOR AN INDICIA READER filed Dec. 12, 2014 (Todeschini);
U.S. patent application Ser. No. 14/573,022 for DYNAMIC DIAGNOSTIC INDICATOR GENERATION filed Dec. 17, 2014 (Goldsmith);
U.S. patent application Ser. No. 14/578,627 for SAFETY SYSTEM AND METHOD filed Dec. 22, 2014 (Ackley et al.);
U.S. patent application Ser. No. 14/580,262 for MEDIA GATE FOR THERMAL TRANSFER PRINTERS filed Dec. 23, 2014 (Bowles);
U.S. patent application Ser. No. 14/590,024 for SHELVING AND PACKAGE LOCATING SYSTEMS FOR DELIVERY VEHICLES filed Jan. 6, 2015 (Payne);
U.S. patent application Ser. No. 14/596,757 for SYSTEM AND METHOD FOR DETECTING BARCODE PRINTING ERRORS filed Jan. 14, 2015 (Ackley);
U.S. patent application Ser. No. 14/416,147 for OPTICAL READING APPARATUS HAVING VARIABLE SETTINGS filed Jan. 21, 2015 (Chen et al.);
U.S. patent application Ser. No. 14/614,706 for DEVICE FOR SUPPORTING AN ELECTRONIC TOOL ON A USER'S HAND filed Feb. 5, 2015 (Oberpriller et al.);
U.S. patent application Ser. No. 14/614,796 for CARGO APPORTIONMENT TECHNIQUES filed Feb. 5, 2015 (Morton et al.);
U.S. patent application Ser. No. 29/516,892 for TABLE COMPUTER filed Feb. 6, 2015 (Bidwell et al.);
U.S. patent application Ser. No. 14/619,093 for METHODS FOR TRAINING A SPEECH RECOGNITION SYSTEM filed Feb. 11, 2015 (Pecorari);
U.S. patent application Ser. No. 14/628,708 for DEVICE, SYSTEM, AND METHOD FOR DETERMINING THE STATUS OF CHECKOUT LANES filed Feb. 23, 2015 (Todeschini);
U.S. patent application Ser. No. 14/630,841 for TERMINAL INCLUDING IMAGING ASSEMBLY filed Feb. 25, 2015 (Gomez et al.);
U.S. patent application Ser. No. 14/635,346 for SYSTEM AND METHOD FOR RELIABLE STORE-AND-FORWARD DATA HANDLING BY ENCODED INFORMATION READING TERMINALS filed Mar. 2, 2015 (Sevier);
U.S. patent application Ser. No. 29/519,017 for SCANNER filed Mar. 2, 2015 (Zhou et al.);
U.S. patent application Ser. No. 14/405,278 for DESIGN PATTERN FOR SECURE STORE filed Mar. 9, 2015 (Zhu et al.);
U.S. patent application Ser. No. 14/660,970 for DECODABLE INDICIA READING TERMINAL WITH COMBINED ILLUMINATION filed Mar. 18, 2015 (Kearney et al.);
U.S. patent application Ser. No. 14/661,013 for REPROGRAMMING SYSTEM AND METHOD FOR DEVICES INCLUDING PROGRAMMING SYMBOL filed Mar. 18, 2015 (Soule et al.);
U.S. patent application Ser. No. 14/662,922 for MULTIFUNCTION POINT OF SALE SYSTEM filed Mar. 19, 2015 (Van Horn et al.);
U.S. patent application Ser. No. 14/663,638 for VEHICLE MOUNT COMPUTER WITH CONFIGURABLE IGNITION SWITCH BEHAVIOR filed Mar. 20, 2015 (Davis et al.);
U.S. patent application Ser. No. 14/664,063 for METHOD AND APPLICATION FOR SCANNING A BARCODE WITH A SMART DEVICE WHILE CONTINUOUSLY RUNNING AND DISPLAYING AN APPLICATION ON THE SMART DEVICE DISPLAY filed Mar. 20, 2015 (Todeschini);
U.S. patent application Ser. No. 14/669,280 for TRANSFORMING COMPONENTS OF A WEB PAGE TO VOICE PROMPTS filed Mar. 26, 2015 (Funyak et al.);
U.S. patent application Ser. No. 14/674,329 for AIMER FOR BARCODE SCANNING filed Mar. 31, 2015 (Bidwell);
U.S. patent application Ser. No. 14/676,109 for INDICIA READER filed Apr. 1, 2015 (Huck);
U.S. patent application Ser. No. 14/676,327 for DEVICE MANAGEMENT PROXY FOR SECURE DEVICES filed Apr. 1, 2015 (Yeakley et al.);
U.S. patent application Ser. No. 14/676,898 for NAVIGATION SYSTEM CONFIGURED TO INTEGRATE MOTION SENSING DEVICE INPUTS filed Apr. 2, 2015 (Showering);
U.S. patent application Ser. No. 14/679,275 for DIMENSIONING SYSTEM CALIBRATION SYSTEMS AND METHODS filed Apr. 6, 2015 (Laffargue et al.);
U.S. patent application Ser. No. 29/523,098 for HANDLE FOR A TABLET COMPUTER filed Apr. 7, 2015 (Bidwell et al.);
U.S. patent application Ser. No. 14/682,615 for SYSTEM AND METHOD FOR POWER MANAGEMENT OF MOBILE DEVICES filed Apr. 9, 2015 (Murawski et al.);
U.S. patent application Ser. No. 14/686,822 for MULTIPLE PLATFORM SUPPORT SYSTEM AND METHOD filed Apr. 15, 2015 (Qu et al.);
U.S. patent application Ser. No. 14/687,289 for SYSTEM FOR COMMUNICATION VIA A PERIPHERAL HUB filed Apr. 15, 2015 (Kohtz et al.);
U.S. patent application Ser. No. 29/524,186 for SCANNER filed Apr. 17, 2015 (Zhou et al.);
U.S. patent application Ser. No. 14/695,364 for MEDICATION MANAGEMENT SYSTEM filed Apr. 24, 2015 (Sewell et al.);
U.S. patent application Ser. No. 14/695,923 for SECURE UNATTENDED NETWORK AUTHENTICATION filed Apr. 24, 2015 (Kubler et al.);
U.S. patent application Ser. No. 29/525,068 for TABLET COMPUTER WITH REMOVABLE SCANNING DEVICE filed Apr. 27, 2015 (Schulte et al.);
U.S. patent application Ser. No. 14/699,436 for SYMBOL READING SYSTEM HAVING PREDICTIVE DIAGNOSTICS filed Apr. 29, 2015 (Nahill et al.);
U.S. patent application Ser. No. 14/702,110 for SYSTEM AND METHOD FOR REGULATING BARCODE DATA INJECTION INTO A RUNNING APPLICATION ON A SMART DEVICE filed May 1, 2015 (Todeschini et al.);
U.S. patent application Ser. No. 14/702,979 for TRACKING BATTERY CONDITIONS filed May 4, 2015 (Young et al.);
U.S. patent application Ser. No. 14/704,050 for INTERMEDIATE LINEAR POSITIONING filed May 5, 2015 (Charpentier et al.);
U.S. patent application Ser. No. 14/705,012 for HANDS-FREE HUMAN MACHINE INTERFACE RESPONSIVE TO A DRIVER OF A VEHICLE filed May 6, 2015 (Fitch et al.);
U.S. patent application Ser. No. 14/705,407 for METHOD AND SYSTEM TO PROTECT SOFTWARE-BASED NETWORK-CONNECTED DEVICES FROM ADVANCED PERSISTENT THREAT filed May 6, 2015 (Hussey et al.);
U.S. patent application Ser. No. 14/707,037 for SYSTEM AND METHOD FOR DISPLAY OF INFORMATION USING A VEHICLE-MOUNT COMPUTER filed May 8, 2015 (Chamberlin);
U.S. patent application Ser. No. 14/707,123 for APPLICATION INDEPENDENT DEX/UCS INTERFACE filed May 8, 2015 (Pape);
U.S. patent application Ser. No. 14/707,492 for METHOD AND APPARATUS FOR READING OPTICAL INDICIA USING A PLURALITY OF DATA SOURCES filed May 8, 2015 (Smith et al.);
U.S. patent application Ser. No. 14/710,666 for PRE-PAID USAGE SYSTEM FOR ENCODED INFORMATION READING TERMINALS filed May 13, 2015 (Smith);
U.S. patent application Ser. No. 29/526,918 for CHARGING BASE filed May 14, 2015 (Fitch et al.);
U.S. patent application Ser. No. 14/715,672 for AUGUMENTED REALITY ENABLED HAZARD DISPLAY filed May 19, 2015 (Venkatesha et al.);
U.S. patent application Ser. No. 14/715,916 for EVALUATING IMAGE VALUES filed May 19, 2015 (Ackley);
U.S. patent application Ser. No. 14/722,608 for INTERACTIVE USER INTERFACE FOR CAPTURING A DOCUMENT IN AN IMAGE SIGNAL filed May 27, 2015 (Showering et al.);
U.S. patent application Ser. No. 29/528,165 for IN-COUNTER BARCODE SCANNER filed May 27, 2015 (Oberpriller et al.);
U.S. patent application Ser. No. 14/724,134 for ELECTRONIC DEVICE WITH WIRELESS PATH SELECTION CAPABILITY filed May 28, 2015 (Wang et al.);
U.S. patent application Ser. No. 14/724,849 for METHOD OF PROGRAMMING THE DEFAULT CABLE INTERFACE SOFTWARE IN AN INDICIA READING DEVICE filed May 29, 2015 (Barten);
U.S. patent application Ser. No. 14/724,908 for IMAGING APPARATUS HAVING IMAGING ASSEMBLY filed May 29, 2015 (Barber et al.);
U.S. patent application Ser. No. 14/725,352 for APPARATUS AND METHODS FOR MONITORING ONE OR MORE PORTABLE DATA TERMINALS (Caballero et al.);
U.S. patent application Ser. No. 29/528,590 for ELECTRONIC DEVICE filed May 29, 2015 (Fitch et al.);
U.S. patent application Ser. No. 29/528,890 for MOBILE COMPUTER HOUSING filed Jun. 2, 2015 (Fitch et al.);
U.S. patent application Ser. No. 14/728,397 for DEVICE MANAGEMENT USING VIRTUAL INTERFACES CROSS-REFERENCE TO RELATED APPLICATIONS filed Jun. 2, 2015 (Caballero);
U.S. patent application Ser. No. 14/732,870 for DATA COLLECTION MODULE AND SYSTEM filed Jun. 8, 2015 (Powilleit);
U.S. patent application Ser. No. 29/529,441 for INDICIA READING DEVICE filed Jun. 8, 2015 (Zhou et al.);
U.S. patent application Ser. No. 14/735,717 for INDICIA-READING SYSTEMS HAVING AN INTERFACE WITH A USER'S NERVOUS SYSTEM filed Jun. 10, 2015 (Todeschini);
U.S. patent application Ser. No. 14/738,038 for METHOD OF AND SYSTEM FOR DETECTING OBJECT WEIGHING INTERFERENCES filed Jun. 12, 2015 (Amundsen et al.);
U.S. patent application Ser. No. 14/740,320 for TACTILE SWITCH FOR A MOBILE ELECTRONIC DEVICE filed Jun. 16, 2015 (Bandringa);
U.S. patent application Ser. No. 14/740,373 for CALIBRATING A VOLUME DIMENSIONER filed Jun. 16, 2015 (Ackley et al.);
U.S. patent application Ser. No. 14/742,818 for INDICIA READING SYSTEM EMPLOYING DIGITAL GAIN CONTROL filed Jun. 18, 2015 (Xian et al.);
U.S. patent application Ser. No. 14/743,257 for WIRELESS MESH POINT PORTABLE DATA TERMINAL filed Jun. 18, 2015 (Wang et al.);
U.S. patent application Ser. No. 29/530,600 for CYCLONE filed Jun. 18, 2015 (Vargo et al);
U.S. patent application Ser. No. 14/744,633 for IMAGING APPARATUS COMPRISING IMAGE SENSOR ARRAY HAVING SHARED GLOBAL SHUTTER CIRCUITRY filed Jun. 19, 2015 (Wang);
U.S. patent application Ser. No. 14/744,836 for CLOUD-BASED SYSTEM FOR READING OF DECODABLE INDICIA filed Jun. 19, 2015 (Todeschini et al.);
U.S. patent application Ser. No. 14/745,006 for SELECTIVE OUTPUT OF DECODED MESSAGE DATA filed Jun. 19, 2015 (Todeschini et al.);
U.S. patent application Ser. No. 14/747,197 for OPTICAL PATTERN PROJECTOR filed Jun. 23, 2015 (Thuries et al.);
U.S. patent application Ser. No. 14/747,490 for DUAL-PROJECTOR THREE-DIMENSIONAL SCANNER filed Jun. 23, 2015 (Jovanovski et al.); and
U.S. patent application Ser. No. 14/748,446 for CORDLESS INDICIA READER WITH A MULTIFUNCTION COIL FOR WIRELESS CHARGING AND EAS DEACTIVATION, filed Jun. 24, 2015 (Xie et al.).

In the specification and/or figures, various embodiments of the present invention have been disclosed. The present invention is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

1. A printer comprising:
a thickness detection module comprising:
a pinch arm assembly comprising:
a pinch arm having a first end and a second end;
an encoder disposed at the second end of the pinch arm, the encoder configured to rotate in response to engagement of the pinch arm with at least a portion of the print media;
a dual channel encoder sensor proximate the encoder and configured to detect a rotation direction and an encoder count indicative of rotation movement of the encoder with respect to the dual channel encoder; and
a processor communicatively coupled to the thickness detection module to calculate a print media thickness of the portion of the print media based on the encoder count and adjust a print head pressure based on the calculated print media thickness.

2. The printer according to claim 1, wherein:
the processor calculates the print media thickness from the encoder count using a conversion factor; and
the conversion factor is one of a predetermined value and a value computed using the encoder resolution.

3. The printer according to claim 1, wherein the encoder count comprises a number of circumferentially spaced line pairs on the encoder that pass by the dual channel encoder sensor as the pinch arm and encoder rotates.

4. The printer according to claim 1, wherein the rotation direction changes each time the print media thickness changes, the rotation direction comprising a first rotation direction and a second rotation direction, the pinch arm and encoder rotating in the first rotation direction in response to an increase in the print media thickness and in the opposite second rotation direction in response to a decrease in the print media thickness.

5. The printer according to claim 4, wherein the encoder count increases with rotation in the first rotation direction and the encoder count decreases with rotation in the opposite second rotation direction.

6. The printer according to claim 5, wherein the pinch arm and encoder are configured to rotate in the first rotation direction in response to engagement with at least the portion of the print media comprising a print medium portion overlying a liner portion and in the opposite second rotation direction in response to engagement with at least the portion of the print media comprising a liner only portion, the encoder count from rotation in the first rotation direction comprising a first encoder count and the encoder count from rotation in the second rotation direction comprising a second encoder count that is less than the first encoder count.

7. The printer according to claim 6, wherein the print media thickness of the print medium portion overlying the liner portion is calculated from the first encoder count and the print media thickness of the liner only portion of the print media is calculated from the second encoder count, a thickness of the print medium calculated by subtracting print media thickness calculated from the second encoder count from the print media thickness calculated from the first encoder count.

8. The printer according to claim 1, wherein the first end of the pinch arm comprises a print media engagement end that engages with a top portion of at least the portion of the print media that is clamped between the print media engagement end and a top of a support base and that disengages therefrom when the pinch arm is not engaged with at least the portion of the print media.

9. The printer according to claim 8, wherein the pinch arm extends radially from a media guide, the pinch arm comprising an elongated substantially planar bar movably mounted on the media guide for rotation with respect to the media guide.

10. The printer according to claim 1, wherein the pinch arm assembly comprises a biasing element for biasing the pinch arm toward a support base and into engagement with at least the portion of the print media.

11. The printer according to claim 10, comprising a bracket above the support base for mounting of the biasing element, wherein a media roll disposed on a media supply spindle of the printer is configured to rotate in a predetermined direction to have the print media thereof fed into and passed through a channel defined between the bracket and the support base.

12. The printer according to claim 1, wherein the thickness detection module is located in the printer along a media path prior to a thermal print head utilized to thermally transfer a portion of ink from an ink ribbon in a ribbon roll to the print media with a thermal print head (TPH) pressure that is automatically adjusted for the calculated print media thickness.

13. (canceled)

14. The printer according to claim 1, comprising a stop sensor communicatively coupled to the processor to indicate the presence of a print media in the printer.

15. A method for detecting the thickness of print media in a printer, the method comprising:
setting an encoder count to zero in response to receiving a no print media sensor signal;
receiving a signal from a dual channel encoder sensor proximate an encoder disposed at an end of a pinch arm, the signal representing a rotation direction and an encoder count as the encoder rotates in the rotation direction and passes by the dual channel encoder sensor; //and//
calculating a print media thickness of the print media based on the encoder count; and
adjusting the print head pressure based on the calculated print media thickness.

16. The method according to claim 15, wherein the encoder count comprises a number of circumferentially spaced line pairs on the encoder that, during a time interval, pass by the dual channel encoder sensor as the pinch arm and encoder rotate in the rotation direction.

17. The method according to claim 15, wherein receiving the signal comprises receiving a first signal representing a first rotation direction and a first encoder count, and in response to receiving the first signal, calculating the print media thickness of a portion of the print media from the first encoder count.

18. The method according to claim 17, wherein receiving the signal comprises receiving a second signal representing an opposite second rotation direction and a second encoder count, as the pinch arm and encoder rotate in the second rotation direction, and in response to receiving the second signal, calculating the print media thickness of a different portion of the print media from the second encoder count.

19. An assembly configured to detect a print media thickness in a printer, the assembly comprising:
a pinch arm having a first end and a second end;
an encoder disposed at the second end of the pinch arm, the encoder configured to rotate in response to engagement of the pinch arm with at least a portion of the print media;
a dual channel encoder sensor proximate the encoder and configured to detect a rotation direction and an encoder count indicative of rotation movement of the encoder in a single rotational direction with respect to the dual channel encoder; and
a biasing element for urging the pinch arm into engagement with at least the portion of the print media.

20. The assembly according to claim 19, wherein the encoder comprises of a number of circumferentially spaced line pairs, the pinch arm and encoder configured to rotate in response to engagement of the pinch arm with at least the portion of the print media.
